(19) United States
(12) Patent Application Publication
(10) Pub. No.: US 2026/0300282 A1
(43) Pub. Date: Oct. 1, 2026

(54) QUERY TRANSLATION SYSTEM TO COMPLEMENT CROSS-SCHEMA DATABASE MIGRATIONS

(71) Applicant: Microsoft Technology Licensing, LLC, Redmond, WA (US)

(72) Inventor: Xinye TANG, Issaquah, WA (US)

(21) Appl. No.: 19/089,253

(22) Filed: Mar. 25, 2025

(51) Int. Cl. G06F 16/2452; G06F 16/22; G06F 40/30

(52) U.S. Cl. CPC G06F 16/2452; G06F 16/22; G06F 40/30

(57) ABSTRACT

A method disclosed herein translates database queries between query languages and across databases that utilize different schemas. The method includes accessing knowledge graphs in response to receiving a query translation request. The knowledge graphs correspond to different databases and store schema elements relationships and value constraint information. The method further provides for constructing a metaprompt comprising the initial query, select portions of the knowledge graphs, and an instruction to use the knowledge graphs to help translate the initial query into the translated query.

### BACKGROUND

A Database Management System (DBMS) is software that is used to provide an interface between databases and the set of users or applications that create, manage, and interact with the databases. Different DBMSs are configured to receive and process requests in different query languages. Examples of query languages include Structured Query Language (SQL), Kusto Query Language (KQL), Splunk Search Processing Language (SPL), XQuery, Cypher, Gremlin, XQL, and more.

For various reasons, a company or user may elect to migrate data between data databases managed by different DBMSs that utilize different query languages. For example, a company subscribing to the data storage services of one cloud storage provider may decide that an alternate cloud storage provider offers more competitive pricing or is better designed to support usage needs and, as a result, elect to migrate data to resources managed by the alternate cloud storage provider. In still other scenarios, customer data migration may occur when a customer switches between different web-based tools that perform similar functionality and interact with different types of database management systems. For example, Splunk and Microsoft Sentinel are both Security Information and Event Management (SIEM) tools that help organizations collect, analyze, and respond to security events across their IT infrastructure. These competing cloud-based software tools rely on databases accessed via different types of database management systems that utilize different query languages. When a customer decides to “switch” from one of these services to the competing service, it is desirable to facilitate the migration of customer data between systems that utilize different query languages to access data and potentially different database schemas to organize data.

In the aforementioned scenarios, the migration of customer data represents an initial hurdle in the migration process. Another significant challenge relates to translations of customer database queries that customers routinely use to support their nominal business operations. For example, customers often automate complex workloads that interface with databases and facilitate actions such as data ingest or processing of newly ingested database data. When customer data is migrated from one database accessible via a first query language to a second database accessible via a second different query language, those automated customer workloads may have to be re-written or otherwise “translated” using available tools. For customers with thousands of automated workloads, this query translation is a major deterrent to migrating data in the first place.

### SUMMARY

According to one implementation, a method provides for receiving a request to translate an initial query directed to a first database into a translated query directed to a second database accessible via a different query language and according to a different database schema. In response to the request, knowledge graphs are accessed to retrieve relevant contextual data pertaining to the database schemas of the first and second database. The knowledge graphs identify database schema elements, relationships between the database schema elements, and value constraint information pertaining to values stored within the first database and the second database. The method further provides for constructing a metaprompt that comprises the initial query, the contextual data, and an instruction to use the contextual data to help translate the initial query into the translated query. The metaprompt is provided to a language model and the translated query is received from the language model in response.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTION OF THE DRAWINGS

FIG. 1 illustrates an example query translation system that utilizes knowledge graphs to inform translations of queries across query languages and between different database schemas.

FIG. 2A illustrates a simplified example of a source database knowledge graph that includes database schema elements represented as individual nodes.

FIG. 2B illustrates a simplified example of a destination database knowledge graph that stores an identical dataset to that of the source database represented by FIG. 2A but according to a different database schema.

FIG. 3 illustrates another example query translation system that utilizes contextual data to inform query translations between different query languages and across different database schemas.

FIG. 4 illustrates another example query translation system that utilizes contextual data to inform query translations between different query languages and across different database schemas.

FIG. 5 illustrates an example query translation system that includes multiple intelligent agents configured for specialized tasks that generate different types of contextual data that provided to a language model along with a translation request.

FIG. 6 illustrates example operations for using artificial intelligence to translate database queries across query languages and between databases that organize data according to different database schemas.

FIG. 7 illustrates an example computing device for use in implementing the described technology.

### DETAILED DESCRIPTION

When customer data is migrated between source and destination databases accessed via DMBS systems that support different query languages, it is often desirable or necessary to translate various customer workloads from the query language of the source database to the query language of the destination database. In scenarios where the source and destination database utilize identical database schemas, this translation depends primarily upon a working knowledge of the two query languages used by the two databases. If, however, the two databases utilize different database schemas, such as by using different table and column names or by splitting one or more tables of the first database across two or more different tables of the second database, then query translation becomes a much more complicated task that depends upon working knowledge of the exact schemas employed. Available tools designed to perform these translations are wrought with flaws, resulting in many failed translations that do not execute properly. Consequently, query translation is an onerous and time-consuming task that requires substantial manual effort and specialized knowledge of both database schemas and the two different query languages.

The herein-disclosed technology includes a database query translation system that leverages semantic inferencing of a language model to generate highly accurate query translations. The disclosed system includes one or more specialized intelligent agents designed to assimilate novel types of contextual data that is ultimately included in a set of inputs, referred to herein as a “metaprompt” provided to a language model. A metaprompt includes an instruction (e.g., a prompt) in addition to metadata that is intended to assist in processing the instruction. A metaprompt may, for example, include a query translation request, contextual data, and an instruction to use the contextual data as a resource to help process and carry out the query translation request.

The metaprompts disclosed herein incorporate novel types of contextual data that make it possible for the language model to make semantic inferences about query purpose as well as about the type of data stored by each database schema element. When these types of semantic inferences are leveraged to map each code block from one query language to another, the resulting translated queries are more accurate than those that result from existing rule-based (algorithmic) translation approaches.

According to one implementation, the herein-disclosed database query translation system includes a knowledge graph construction component that maps relationships between schema elements and value constraints defined with respect to both the source and destination database. During the translation of a code block that represents a query, the pre-created knowledge graphs are retrieved for both the source and destination databases. These knowledge graphs are included, along with the query to be translated, to a language model, and the language model is instructed to use the knowledge graphs as a data resource when translating the query between the source query language and the destination database query language. For example, the language model is instructed to the defined schema relationships and value constraints of the knowledge graphs to make inferences about cross-schema relationships such that schema elements referenced in the code block (e.g., of the source database schema) can be mapped to corresponding schema elements defined within destination database.

In the same or other implementations, the query translation system includes a feedback loop autonomously driven by a query test component. The query test component “tests” each translated query that is generated by attempting to execute it against the destination database. If the execution attempt returns a runtime error, an updated metaprompt is created and passed to the language model with a request to “re-try” the translation based, at least in part, on the runtime error observed. Through this process, the language model learns associations between specific runtime errors and query translation errors, which allows the language model to gradually reduce the number of translation errors that it makes over time.

According to still other implementations, the query translation system includes other types of specialized intelligent agents that perform knowledge retrieval tasks such as schema element description retrieval and/or relevant query/translation example retrieval (“shots”), which are then included in the contextual data of the metaprompt that is passed to the language model. The various types of novel contextual data described herein may, in different implementations, be used in isolation of one another (with different systems employing subsets of the types of contextual data disclosed herein) or, instead, collectively within a single system. In one implementation, a query translation system implementing the disclosed technology includes a plurality of knowledge-retrieval agents that specialize in different tasks such as code block annotation, knowledge graph construction, schema element description generation or retrieval, and relevant “shot” (query/translation example) retrieval, with the outputs of the multiple agents being collectively assimilated into the body of “contextual data” that is passed to a language model along with a query to be translated.

Due to the techniques employed by the herein-disclosed translation systems, query translations can be executed across query languages, databases, and database schemas with higher accuracy than other presently existing (rule-based) approaches.

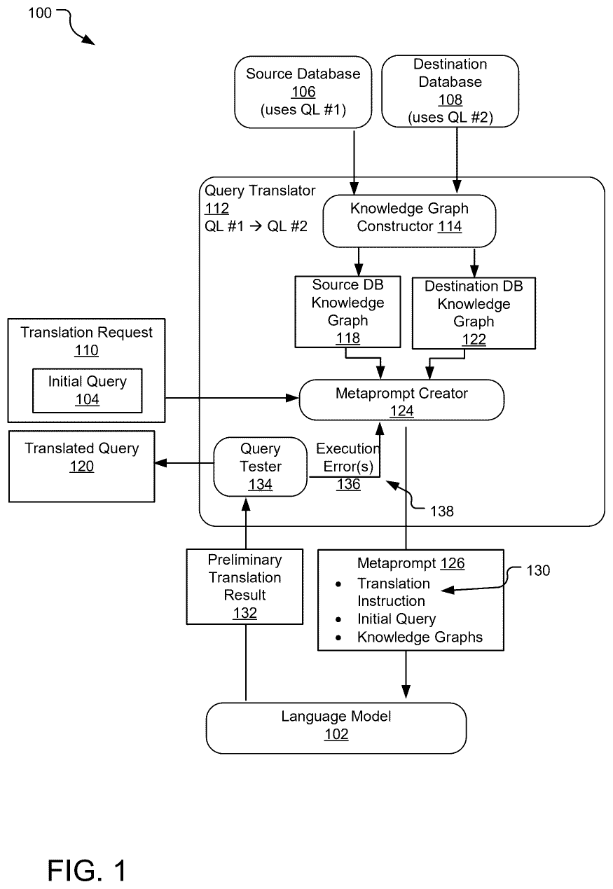

FIG. 1 illustrates an example query translation system 100 that utilizes contextual data in the form of a knowledge graph to inform translations of queries across query languages and between different database schemas. In contrast to existing query translation approaches that rely on static rules, the query translation system 100 relies primarily upon semantic inferencing of a language model 102 to translate a query (e.g., initial query 104) that is executable to retrieve requested data from a source database 106 into a translated query 120 that is executable to retrieve the same requested data from a destination database 108.

In one implementation, the source database 106 represents a database used by a customer prior to a migration of the customer's data to the destination database 108. It is assumed that the source database 106 is accessible via a DMBS that utilizes a first query language (QL#1), and the destination database 108 is accessible via a different DMBS that utilizes a second query language (QL#2). Although not required, it is contemplated that the source database 106 and the destination database 108 may store the same customer dataset according to different database schemas. For example, corresponding tables, columns (fields), and rows (records) may have different names, and it is possible that some tables in the source database do not map via a 1-to-1 table mapping, with a corresponding table in the destination database 108. For example, data stored within a single table in the source database 106 may be split across two or more different tables in the destination database 108.

In the system 100, the initial query 104 is provided to a query translator 112 as part of a translation request 110. The initial query 104 requests to access or manipulate a subset of the data stored in the source database 106 and includes one or more lines of code drafted in the first query language. In addition to the initial query 104, the translation request 110 may also identify the destination database 108 by name and the second query language (QL#2) that is used by the destination database 108.

In an implementation where the initial query 104 represents a component of a larger workload being translated, the query translator 112 iteratively receives different code blocks from the larger workload and performs query translation operations on each of those code blocks, per the general flow of operations shown in FIG. 1 and described below. In one implementation, an external process facilitates the block-by-block translation of the larger workload by parsing the workload into smaller code blocks that include a single database query and iteratively passing the code blocks to the query translator 112. In this implementation, the external process receives translated code blocks (e.g., a translated query 120) output by the query translator 112 and aggregates the translated code blocks together to create a translated version of the workload. The external process may provide the query translator 112 with the identity of the destination database 108 and a parameter identifying the second query language during an initial configuration process. For example, an ID for the destination database and indication of the second query language are passed to the query translator 112 a single time for the entire workload rather than with each individual one of the code blocks in the workload.

The query translator 112 is, in one implementation, a cloud-based software component that can be selectively configured to facilitate translations between different pairs of source and destination databases. In other implementations, the query translator 112 is locally stored and/or locally executed on the machine of the end customer (e.g., the owner of data stored in the source and destination databases) or server(s) of one the two database providers. Different components of the query translator 112 may be stored on or executed by different physical machines.

When configuring the query translator 112 to translate queries with respect to a new pair of databases (e.g., queries for the source database 106 into queries executable on the destination database 108), a user (e.g., technical admin) configures a knowledge graph constructor 114 for access to each database in the pair. During this initial configuration, a knowledge graph constructor 114 performs operations to generate knowledge graphs that illustrate aspects of the database schema used to organize data in the source database and in the destination database, respectively. Specifically, the knowledge graph constructor 114 outputs a source DB knowledge graph 118 that contains information describing the schema used by the source database and a destination DB knowledge graph 122 that contains information describing the schema used by the destination database 108.

To create the source DB knowledge graph 118 and the destination DB knowledge graph 122, the knowledge graph constructor 114 uses an application programming interface (API) to discover the names of tables and respective columns stored within each database. The knowledge graph constructor 114 then analyzes relationships between values stored in different columns to discover columns that store values corresponding to the unique row identifiers in other tables. In some database systems, this type of relationship is called a “foreign key.” For example, a table that stores “Orders” may have a “Customer ID” column that stores identifiers that correspond to the primary keys (e.g., row identifiers) in another table titled “Customers.” Depending on the query language used, there may or may not exist a database operation that is invokable to discover primary and foreign keys. However, primary and foreign key relationships can likewise be discovered by analyzing table values to identify sets of column values that likewise appear as row identifiers elsewhere in the database.

In addition to discovering relationship information between tables and columns and between columns (e.g., primary and foreign keys) within a single database, the knowledge graph constructor 114 also discovers data types corresponding to the values stored in different columns. For example, data types may include numeric data types (e.g., integer values, float values, double values), string data types, data and type data types, a Boolean data type, binary data types, JSON or XML data types, enumerated data types, and more.

The source DB knowledge graph 118 and destination DB knowledge graph 122 are populated with the discovered database schema and value information. In one implementation, the knowledge graphs include nodes that correspond to the names of schema elements-e.g., tables and columns- and edges between nodes that represent relationships between the schema elements. The edges store metadata indicating different types of relationships (e.g., indicating which table each column belongs to, which columns store corresponding sets of values, data types stored within each column, and/or enumerated values stored within the columns).

The source DB knowledge graph 118 and the destination DB knowledge graph 122 are input to metaprompt creator 124, which can be understood as a software component that assimilates its respective inputs into a set of inputs that includes an instruction (e.g., a prompt) instructing the language model 102 to perform a query translation task. In FIG. 1 and other implementations of the query translation systems described herein, this set of inputs provided to the language model 102 is referred to as a “metaprompt” (e.g., metaprompt 126). It is contemplated that in some implementations, the metaprompt 126 is passed to the language model 102 as multiple separate or independently-processed inputs, some of which may not include an actual prompt (affirmative instruction). For example, the language model 102 may be an intelligence agent that is trained to repeatedly execute a same instruction such that it is not necessary to provide the instruction to the language model 102 along with the set of inputs.

The language model 102 is a model trained to analyze textual inputs and may, for example, be a natural language processing (NLP) model or a multimodal model that can receive prompts that include various types of input (e.g., text, image, audio, and/or video data) and likewise generate outputs of multiple types that are not necessarily the same as the input type. Further examples of language models include transformer-based models such as generative pre-trained transformer (GPT) models, Open Pretrained Transformer (OPT) models, and Bidirectional Encoder Representations from Transformers (BERT) models, as well as Bioscience Large Open-science Open-access Multilingual (BLOOM) models, seq2seq models, long short-term memory (LSTM) network, and recurrent neural networks (RNNs). Examples of publicly available multimodal language models include the Mistral AI model and the large language model Meta AI (LLaMa) model.

In the implementation of FIG. 1, the metaprompt 126 includes the source DB knowledge graph 118 and the destination DB knowledge graph 122 in a structured text format that is readable by the language model 102. Additionally, the metaprompt 126 includes the initial query 104 and an instruction to translate the initial query 104 from the first query language (QL#1) into the second query language (QL#2) (shown as “translation instruction 130”). In one implementation, the translation instruction 130 specifies that the initial query 104 is to a database with a database schema and value constraints described within the source DB knowledge graph 118 and further specifies that the translated query 120 is to be executable on a database with a database schema and value constraints as described within the destination DB knowledge graph 122. The translation instruction 130 may, in some implementations, include a further instruction that encourages the language model 102 to look for patterns/similarities in value constraint information that is stored as metadata for different graph nodes or edges when determining how the schema elements referenced in the initial query 104 (and shown in the source DB knowledge graph 118) map to corresponding schema elements in the destination DB knowledge graph 122.

The language model 102 receives the metaprompt 126, processes the translation instruction 130 in view of the contextual data (e.g., the knowledge graphs), and generates a preliminary translation result 132 that is passed to a query tester 134. The query tester 134 is a software component that attempts to execute the preliminary translation result 132 on the destination database 108. If the preliminary translation result 132 is executed to access the requested information from the destination database 108 without error, the preliminary translation result 132 is output by the query translator 112 (returned to the requesting query or process) as the translated query 120 (the final output). If, however, the attempt to execute the preliminary translation result 132 returns an execution error, the query tester 134 passes the execution error back to the metaprompt creator 124 as part of an error feedback loop 138.

In response to receiving one or more execution errors 136 via the error feedback loop 138, the metaprompt creator 124 executes logic to generate a new set of inputs to the language model 102, referred to herein as an “updated version” of the metaprompt 126. In one implementation, the updated version of the metaprompt 126 includes some of the same information as the initial version of the metaprompt 126-namely, the initial query 104 and the knowledge graphs for the source and destination databases. However, the updated version of the metaprompt 126 additionally includes the preliminary translation result 132, the execution error(s) 136, and an updated version of the translation instruction 130 that instructs the language model 102 to translate the initial query 104 again (e.g., per the initial translation instruction 130) but to use the preliminary translation result 132 and the execution errors 136 to inform the correction of errors that were present in the preliminary translation result 132.

In response to processing the updated version of the metaprompt 126, the language model 102 outputs another instance of the preliminary translation result 132, and the query tester 134 again attempts to execute the preliminary translation result 132 on the destination database 108. If another execution error is observed, the execution error is appended to the execution error(s) 136 and passed back to the metaprompt creator 124 for yet another translation attempt based on the newest error information.

The error feedback loop 138 facilitates “re-tries” that allow the query translator 112 to self-correct errors, thereby fully automating query translation to guarantee error-free execution of translated queries. This “re-try” approach also allows the language model 102 to learn from its own errors. Through repeated iterations of the error feedback loop 138 with respect to different query translation attempts, the language model 102 learns associations between specific runtime errors and query translation errors, which allows the language model 102 to gradually reduce the number of translation error that it makes over time.

Some implementations of the system 100 do not include the query tester 134 or the error feedback loop 138. In such implementations, query testing may be delegated to the requesting process. Alternatively, some implementations of the query translator 112 include the query tester 134 but do not include the error feedback loop 138. In these implementations, translation queries that fail testing are flagged for follow-up (e.g., manual) review.

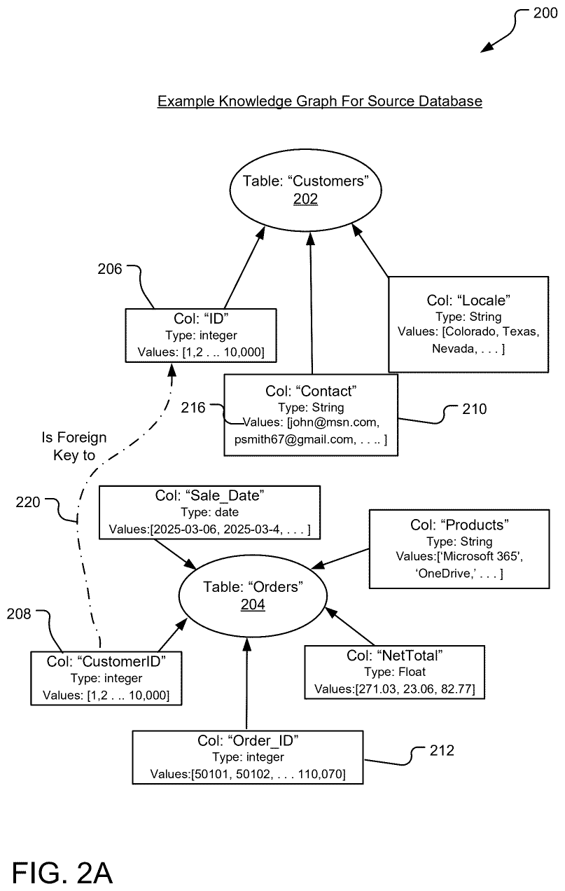

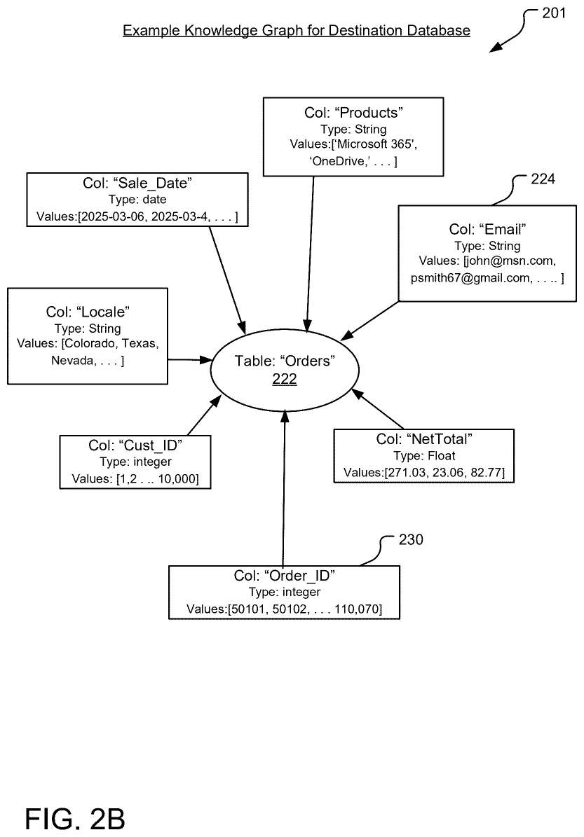

FIGS. 2A and 2B illustrate example knowledge graphs that may be included within contextual data passed to a language model along with a query translation instruction, per the methodology generally described with respect to FIG. 1. Specifically, FIG. 2A illustrates a simplified example of a source database knowledge graph 200 that includes database schema elements (e.g., table names and column names) represented as individual nodes. The source database knowledge graph 200 includes two tables, titled “Customers” and “Orders,” which are represented as oval-shaped nodes 202 and 204. The source database knowledge graph 200 also represents columns as rectangles (e.g., column nodes 206, 208, 210, 212).

Table nodes store table names, whereas column nodes store column names along with value constraint information. Specifically, the value constraint information includes a data type identifier (e.g., data type 218 in column node 210) that is descriptive of the values stored in the corresponding column. For example, the “Customers” table includes a column node 210 named “contact” and is used to store email addresses that are of data type “string.” In the illustrated example, the value constraint information that is stored as metadata for each column node further includes sample values 216 that may, in various implementations, assume different forms.

In some implementations, the sample values 216 identify a value range that is inclusive of the values stored in the corresponding column, such as either by describing the range in terms of min/max values or by explicitly listing an enumerated set of possible values (e.g., 1 or 0 being the possible values if the data type is binary). If, for example, a table column stores values of data type “Enum” (meaning each value is selected from a predefined set of values), the set of predefined selected (Enum) values may be represented in the knowledge graph data corresponding to that column. In other implementations, the sample values 216 include randomly selected values from the corresponding column. If, for example, the data type for a given column is “Char(n)” (a fixed-length string of length ‘n’), the stored metadata for that column may store a sampling of the string values that appear in the column. In some cases, the sampling of values consists of a subset of the column values (e.g., a randomly selected set percentage of the column's values). In still other implementations, the sample values 216 include the complete set of values that appear within the corresponding column.

Edges within the source database knowledge graph 200 represent relationships between nodes. Each edge may have a corresponding relationship type and include metadata identifying the relationship type. For example, a column is related to a table by a “is a column within” relationship type, whereas two columns in different tables may be related by way of a primary/foreign key relationship. In the example shown, solid arrows represent column/table relationships (e.g., with the column node at the base of each solid arrow being included within the table that the arrow points to). An example column-to-column relationship is shown by edge 220. In the example shown, the edge 220 connects column nodes 206 and 208 by way of a primary/foreign relationship. Here, the integer values in the “Cust ID” column of the table “Orders” correspond to the unique identifiers that identify each customer (e.g., each row) in the table “columns.” In this relationship, the values stored in the “Cust ID” column represent “foreign keys” that correspond to the “primary keys” (unique identifiers) that identify each different customer in the “Customers” table. Stated differently, each value stored in the column node 208 (“CustomerID”) is a value that also appears somewhere within the set of values stored by node 206 (“ID”).

In some implementations, metadata stored in edges of the source database knowledge graph 200 further identifies a relationship subtype for each column-to-column relation-e.g., whether there exists a one-to-many relationship, as is the case when a single customer can place many orders or a one-to-one relationship, as is the case when a resource in one table can be associated with at most one other resource in another table.

FIG. 2B illustrates a simplified example of a destination database knowledge graph 201 that stores an identical dataset to that of the source database represented by FIG. 2A but according to a different database schema. The database schema of FIG. 2B includes a single table that consolidates the information spread across the two separate tables of FIG. 2A. Instead of a separate table for “Customers” (storing customer information) and a table for “Orders” (storing order information), there exists a single table node 222, entitled “Orders.” Within the destination database, the “Orders” table stores customer-specific information (e.g., “email”) as attribute data for individual orders, with “Order_ID” serving as the unique identifier (primary key) for each row in the table. One of skill in the art may appreciate that this is not the most efficient database structure due to redundant data storage of some customer information in association with multiple different orders. However, this table nonetheless exemplifies how the data in the source database described with respect to FIG. 2B could potentially be organized according to a different database schema.

Within the destination database knowledge graph 201, some of the column nodes identify column names that differ from corresponding columns (e.g., storing the same data) in the source database, which is represented by the graph of FIG. 2A. For example, the destination database knowledge graph 201 includes a column node 224 identifying a column named “Email,” which stores the same set of values (email addresses) as the “Contact” column (e.g., column node 210) in the “Customers” table of FIG. 2A.

Like the source database knowledge graph 200 in FIG. 2A, the column nodes in the destination database knowledge graph 201 store metadata that identifies both data type and sample values for the corresponding columns. When provided with the graphs of FIG. 2A and FIG. 2B and an indication that these graphs represent schemas in different databases storing the same customer data, a language model can use the graph metadata to make inferences about how the schema elements of the source and destination databases relate to one another.

For example, the language model may receive the sample values identified within the column node 210 (entitled “Contact”) of FIG. 2A and the sample values stored in the column node 224 (entitled “Email) in FIG. 2B and, from this information, determine that both of these columns store values of the format “XXXXX@domain.com,” which the language model recognizes as unique to email addresses. Based on this pattern inferencing of the stored sample values, the language model can accurately map the “Contact” column of the “Customers” source database table (of FIG. 2A) to the “Email” column in the “Orders” table of the destination database (of FIG. 2B).

Likewise, the inclusion of value constraints, which identify specific value ranges, can also be a powerful inferencing tool. With this information, the language model can, for example, determine that it is unlikely that the “Order_ID” column in the “Order” table of the destination database (e.g., column node 230 in FIG. 2B) corresponds to the “ID” column in the “Customers” table of the source database (e.g., column node 206 in FIG. 2A) because although both columns store have similar names and store integer values, the two columns store values that are in non-overlapping numerical ranges (e.g., with the column node 230 identifying a numeric range of ~50,000 to ~110,000 and the column node 206 identifying a numeric range of ~1 to ~10,000).

In some scenarios, the “data type” metadata field is by itself (with the sample values) sufficient to prevent incorrect query-translation inferencing. If, for example, a received query includes a reference to a table/column pair named “sales/locale” and the destination database includes a table/column pair named “sale/location,” a logical semantic inference supports the conclusion that these column/table pairs are likely to store the same values. If, however, the language model uses the “data type” metadata field to determine that the “locale” column stores integer values (e.g., zip codes such as 80532, 35712) while the “location” column stores string values (e.g., ‘Asia,’ ‘Europe’), this information may prevent the language model from incorrectly translating a reference to the “locale” column in the source database table to the “location” column in the destination database table.

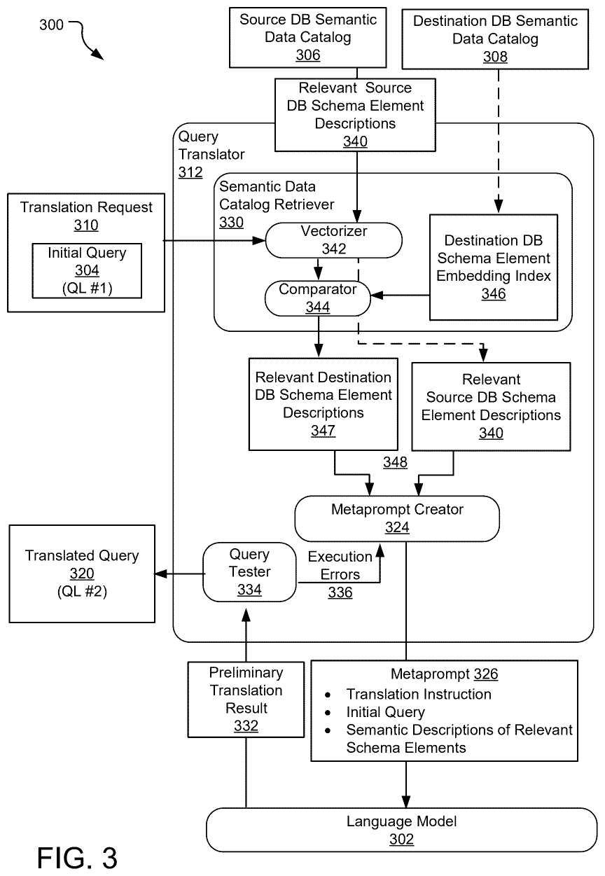

FIG. 3 illustrates another example query translation system 300 that utilizes contextual data to inform query translations between different query languages and across different database schemas. The query translation system 300 includes some of the same components as those described with respect to FIG. 1; however, this system differs from that of FIG. 1 in that it includes a semantic data catalog retriever 330 rather than the knowledge graph constructor. For each newly-received translation request (e.g., a translation request 310 including an initial query 304), the semantic data catalog retriever 330 identifies a set of relevant semantics descriptions to include within a metaprompt 326 that is passed to a language model 302 along with an instruction to perform a query translation based, at least in part, on the semantic descriptions of schema elements included metaprompt 326).

As part of a customer account configuration or customer onboarding process, the query translation system 300 obtains semantic catalogs corresponding to the source and destination databases pertaining to the customer's query translations. In FIG. 3, these semantic catalogs are identified as “source DB semantic data catalog 306” and “destination DB semantic data catalog 308.” In various implementations, these catalogs are derived in different ways. For example, catalog data may be compiled and provided by the end customer, a provider of the query translation system 300, or otherwise derived via automatic processes using techniques that are external to the scope of this disclosure.

The source DB semantic data catalog 306 and destination DB semantic data catalog 308 include brief (e.g., 1-3 sentence) natural-language descriptions for each table name and column name in the corresponding database. These descriptions are referred to herein as “schema element descriptions.” In different implementations, the quantity and types of information included within each schema element description may differ depending on how the descriptions are derived; however, these descriptions generally provide some semantic context that describes the meaning of values stored by each schema element. Typically, a schema element description for a column makes reference to the corresponding table. For example, a descriptor for column “Timestamp” in a table named “Events” may read, “this column stores date-time information for logged events flagged as telemetry anomalies.”

In some implementations, the schema element descriptions include value constraint information, such as information that identifies the data type of values stored by the corresponding schema element. For example, a descriptor for a column “Customer_IDs” may read, “this column stores integer values corresponding to unique customer identifiers.” In other implementations, semantic descriptions may further include descriptions of what specific stored values mean for a specific column. For example, the descriptor for a column titled “Error_Code” may read: “This column stores an integer identifier corresponding to an error code observed in association with the logged event. Enumerated values of the error code include 001 (used for routing errors), 002 (used for connection errors), and 003 (used for authentication errors).”

Due to size limits on language model inputs, it may not be feasible to include the entirety of the source DB semantic data catalog 308 and the destination DB semantic data catalog 308 in the metaprompt 326 that is passed to the language model 302. For this reason, the semantic data catalog retriever 330 performs operations to select a most relevant subset of the data included in these two catalogs. Upon receiving an initial query 304 as part of a translation request 310, the semantic data catalog retriever 330 first identifies schema element names (tables, columns) referenced within the initial query 304. The semantic data catalog retriever 330 may, for example, include a language model trained on texts in various query languages such that the model is readily able to identify and extract table and column names appearing in an initial query 304. Upon extracting the schema element names from the initial query 304, the semantic data catalog retriever 330 retrieves, from the source DB semantic data catalog 306, schema element descriptions that correspond to the schema element names extracted for the initial query 304. These schema element descriptions are referenced in FIG. 1 as “relevant source DB schema elements descriptions 340.”

In one implementation, the relevant source DB schema element descriptions 340 are individually provided to a vectorizer 342 and vectorized such that an embedding is created for each different one of the schema element names and corresponding descriptions identified within the relevant source DB schema element descriptions 340. These embeddings are referenced below as “source database schema element embeddings.”

After creating the source database schema element embeddings, the semantic data catalog retriever 330 performs a vector analysis to identify a most similar set of schema element descriptions within the destination DB semantic data catalog 308 (e.g., an analysis that leads to the identification of a set of “relevant destination DB schema element descriptions 347”). In one implementation, an initial configuration operation for the system 300 includes vectorizing, with the vectorizer 342, the schema element descriptions in the destination DB semantic data catalog 308, and storing the resulting embeddings within a semantic similarity model that includes a comparator 344 and an index of the embeddings, shown as “destination DB schema element embedding index 346.” In this architecture, the relevant source DB schema element descriptions 340 are compared to the various schema element descriptions stored in the destination DB semantic data catalog 308 by computing a similarity metric between respective pairs of embeddings. For example, a comparator 344 computes a cosine similarity or dot product between an embedding corresponding to a select source database schema element description (of the relevant source DB schema element descriptions 340) and each of a plurality of embeddings stored in the destination DB schema element embedding index 346. Based on the cosine similarity computation, the comparator 344 identifies a select destination database schema element description that is “most semantically similar” to the select source database schema element description. This process is, in one implementation, repeated for each one of the relevant source DB schema element descriptions 340, ultimately deriving the relevant destination DB schema element descriptions 347.

The relevant destination DB schema element descriptions 340 and the relevant destination DB schema element descriptions 347 are included in contextual data 348 that is provided to metaprompt creator 324. The metaprompt creator 324 performs functionality similar to that described with respect to FIG. 1—e.g., generating a metaprompt 326 that includes a translation instruction, the initial query 304, and the contextual data (which in this implementation includes the relevant destination DB schema element descriptions 340 and the relevant destination DB schema element descriptions 347). The translation instruction within the metaprompt 326 explains the purpose of the contextual data (e.g., “included are descriptions of schema elements from the source database and destination database that may be relevant in this task”) and further instructs the language model 302 to use the contextual data to help it determine relevant schema element mappings for translating the initial query 304 from the query language of the source database to the query language of the destination database.

In response to receiving and processing the metaprompt 326, the language model 302 outputs a preliminary translation result 332 that is provided to a query tester 334. The query tester 334 performs functionality the same or similar to that described with respect to FIG. 1-namely, attempting to execute the preliminary translation result 332 on the destination database. If the preliminary translation result 332 executes without error, the preliminary translation result 332 is output by the query translator 312 (e.g., returned to the requesting user or process) as translated query 320. If, however, the attempted execution of the preliminary translation result 332 results in one or more execution errors 336, the execution errors 336 are provided as feedback to the metaprompt creator 324, and the metaprompt creator 324 creates a new version of the metaprompt 326 that includes the execution errors and an updated instruction to re-try the translation based, in part, on the observed execution errors (per the operations generally described with respect to FIG. 1). As in the system of FIG. 1, the query tester 334 is optional and may not be included in all implementations of the system 300.

Depending upon the mode by which the schema element descriptions are initially created, it is possible that the descriptions within the source and destination semantic data catalogs may include different information and/or information that is more detailed than the knowledge graphs described with respect to FIG. 1. The inclusion of the relevant schema element descriptions in the metaprompt 326 reduces the complexity of the translation task entrusted to the language model 302 because the language model 302 is, in this implementation, provided with a limited subset of schema element pairs that have already been identified (per the above-described vector similarity analysis) as being most similar pairs of schema element descriptions across the schema elements of the source and destination databases. This limited number of relevant descriptions in the contextual data of the metaprompt 326, paired with the informative descriptions that include value constraint information (e.g., data type identifiers and or explanations of enumerated stored values), increases the accuracy of the translated query 320.

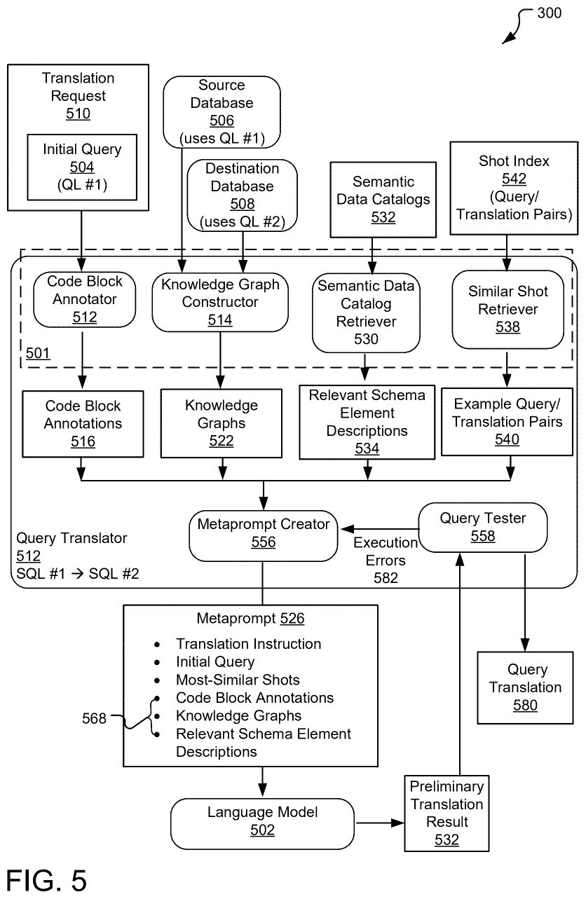

Notably, translation accuracy may be increased further in systems that include both knowledge graphs (as in FIG. 1) and relevant schema element descriptions (as in FIG. 3) in the contextual data that is included in the metaprompt 326, as this allows the language model to use the dependencies in the knowledge graphs to independently verify that the vector similarity analysis (yielding the relevant schema descriptions) actually identified the correct, corresponding pairs. An example of this type of integrated, multi-agent system is shown and described herein with respect to FIG. 5.

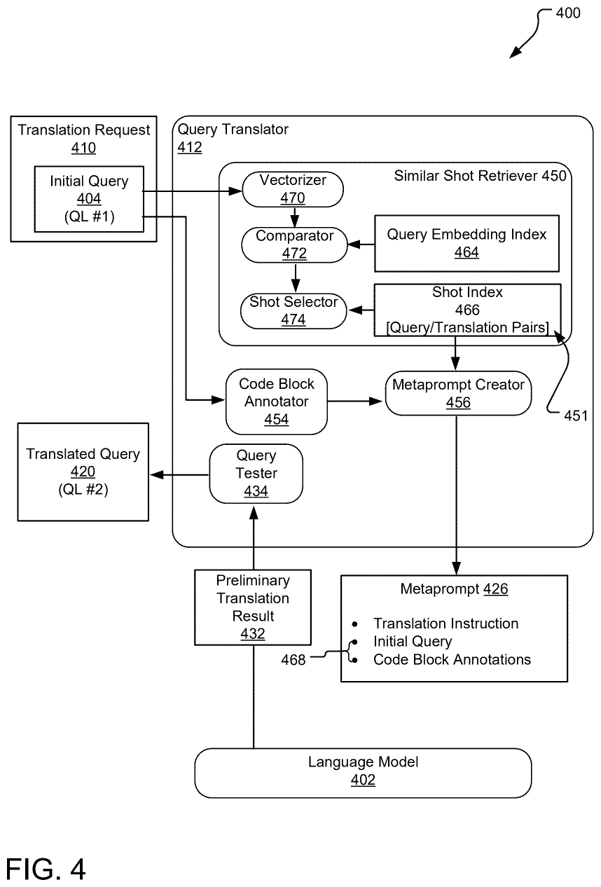

FIG. 4 illustrates another example query translation system 400 that utilizes contextual data to inform query translations between different query languages and across different database schemas. The query translation system 400 includes a code block annotator 454 and a similar shot retriever 450, both of which comprise software elements that generate still additional types of contextual data that are passed to a language model 402 as part of a metaprompt 426 that instructs the language model 402 to translate an initial query 404 directed to a source database (not shown) into an alternate query language used by a destination database that stores the same data according to a different database schema.

Upon receiving a translation request 410 that includes an initial query 404, the code block annotator 454 processes the initial query and generates a natural language annotation that identifies the purpose of the initial query 404 and explains query language operations invoked within the initial query 404 in natural language. For example, the code block annotator 454 includes a natural language model trained on a corpus that includes blocks of code for query languages and corresponding natural language annotations such that the model can generate a natural language description of the functionality of a query language code block received as input. The code block annotator 454 generates a code block annotation that generally explains the function of the initial query 404 based on the query language operations. If, for example, the initial query 404 is a complex SQL query of this form:
SELECT e.employee_id, e.first_name, e.last_name, d.department_name, COUNT(p.project_id) AS project_count
FROM employees e JOIN departments d ON e.department_id=d.department_id
LEFT JOIN projects p ON e.employee_id=p.employee_id
WHERE e.hire_date BETWEEN ‘2020-01-01’ AND ‘2023-12-31’
GROUP BY e.employee_id, e.first_name, e.last_name, d.department_name
HAVING COUNT(p. project_id)>2
ORDER BY project_count DESC;
   The code block annotator 454 may generate an annotation that reads: “This query retrieves a list of employees who were hired between Jan. 1, 2020, and Dec. 31, 2023, along with the number of projects they have worked on. It includes the employee's ID, first name, last name, and the department they belong to. The query joins the “employees” table with the “deparatments” table to get the department name, and also left joins the “projects” table to count the number of projects each employee has participated in. Only employees who have worked on more than two projects are included in the result. The results are grouped by employee ID, first name, last name, and department name, and then ordered by the number of projects (in descending order), so that employees with the most projects appear first.”

Annotations generated by the code block annotator 454 are output and provided to a metaprompt creator 456, which includes the annotations within contextual data 468 of a metaprompt 426 that is, in turn, generated and provided to the language model 402.

In the example of FIG. 4, the contextual data 468 additionally includes a set of example query/translation pairs that are selected for inclusion by the similar shot retriever 450. In one implementation, the similar shot retriever 450 also processes the initial query 404 to generate some of the contextual data 468 that is added to the metaprompt 426. The similar shot retriever 450 includes a shot index 466 that stores pairs of pre-generated (e.g., exemplary) query/translation pairs 451, each of which includes a query that is in the query language of the initial query 404 (e.g., the same query language used by the source database) and a corresponding “translation” of the query that is in the query language used by the destination database. In advance of the illustrated similar shot retriever 450, the queries of the query/translation pairs 451 are vectorized by a vectorizer 470 and stored as embeddings within a query embedding index 464.

In response to receiving the initial query 404, the similar shot retriever 450 vectorizer 470 vectorizes the initial query 404, thereby creating a first query embedding that is defined within the same latent space as the pre-generated query embeddings of the query embedding index 464. A comparator 472 computes a similarity metric, such as a cosine similarity or a dot product, between the first query embedding (corresponding to the initial query 404) and various of the embeddings stored within the query embedding index 464 to identify a similar subset of the stored embeddings (e.g., five to 10 stored query embeddings that are most similar to the first embedding).

Once the comparator 472 identifies the most similar subset of the stored embeddings from the query embedding index 464, a shot selector 474 selects a relevant subset of the query/translation pairs 451 that include the set queries corresponding to (e.g., used to generate) the most similar subset of the stored embeddings. This relevant subset of the query/translation pairs 451 is then provided to the metaprompt creator 456 and included in the contextual data 468 of the metaprompt 426.

In addition to the contextual data 468, the metaprompt 426 includes the initial query 404 and a translation instruction that explains the purpose of the contextual data. For example, the translation instruction may read: “Included with this instruction is a query you are to translate from a [source query language] to a [destination query language]. Along with this query is an annotation that explains the purpose of the query and the number of example query/translation pairs in the relevant languages. Use the annotation and the query/translation pairs to help you translate the query the query.” In response to processing the metaprompt 426, the language model 402 outputs a preliminary translation result 432 that is provided to a query tester 434. The query tester 434 attempts to execute the preliminary translation result 432 on the destination database. If the execution attempt is carried out without query, the preliminary translation result 432 is returned as the translated query 420. Otherwise, observed execution errors are provided as feedback to the metaprompt creator 456, and the metaprompt creator 456 implements the feedback into an updated version of the metaprompt 426, which is provided to the language model to trigger a re-try, per the operations generally described with respect to FIG. 1.

In some implementations, the system 400 includes either the code block annotator 454 or the similar shot retriever 450 rather than both within a single system, as shown. In still other implementations, either or both of these components are integrated within a query translator that also includes one or more of the semantic data catalog retriever FIG. 3, the knowledge graph constructor 114 of FIG. 1, or the query tester 134 of FIG. 1.

FIG. 5 illustrates an example query translation system 500, including a query translator 512 that includes multiple intelligent agents 501 that perform specialized tasks to generate contextual data 568, which is provided to a language model 502 along with a translation request 510. The translation request 510 requests the translation of an initial query 504 from a first query language and schema used by a source database 506 to a second query language and schema used by a destination database 508.

The multiple intelligent agents 501 include a code block annotator 513 that performs operations the same or similar to the code block annotator 454 described with respect to FIG. 4—namely, processing the initial query 504 to generate natural language annotations 516 that identify the purpose of the initial query 504 and that use natural language to explain query language operations invoked.

In addition, the multiple intelligent agents 501 also include a knowledge graph constructor 514 that performs operations the same or similar to the knowledge graph constructor described with respect to FIG. 1—namely, generating knowledge graphs 522 that correspond to the source database 506 and the destination database 508, respectively. The knowledge graphs 522 include nodes corresponding to database schema elements (e.g., table names, column names) and connections between nodes that represent relationships between edges. Column nodes additionally include value constraint information (e.g., data types and sample values), as generally described with respect to FIG. 2A-2B.

The multiple intelligent agents 501 also include a semantic data catalog retriever 530 that performs operations the same or similar to the semantic data catalog retriever 330 described with respect to FIG. 3—namely, identifying relevant schema elements referenced in the initial query 504; retrieving descriptions of those relevant schema elements from a semantic data catalog compiled for the source database 506 (e.g., one of the semantic data catalogs 532), vectorizing those descriptions (generating embeddings), and performing the vector similarity analysis operations described with respect to FIG. 3 to identify a set similar set of element descriptions defined within another one of the semantic data catalogs 532 that stores the schema information for the destination database 508. Per these operations, the semantic data catalog retriever 530 identifies and outputs a set of relevant schema element descriptions 534, which includes the relevant schema element descriptions identified with respect to both the source database 506 and the destination database 508.

In addition to the above, the multiple intelligent agents 501 also include a similar shot retriever 538 that performs operations the same or similar to the similar shot retriever 450 of FIG. 4—namely, identifying set of example query/translation pairs 540 from a shot index 542 that are identified as most relevant to the initial query 504, with relevance being measured based on the degree of semantic similarity between the initial query 504 and the “query” portion of each of the query/translation pairs 540 (e.g., cosine similarity between query embeddings). Specific operations for identifying the sample query/translation pairs 540 may be the same or similar to those described with respect to FIG. 4.

In the system 500, the code block annotations 516, knowledge graphs 522, relevant schema element descriptions 534, and example query/translation pairs 540 (“most-similar shots”) are all provided as input to a metaprompt creator 456 that, in turn, aggregates these inputs into contextual data 568 and generates a metaprompt 526 that includes the initial query 504, the contextual data 568, and an instruction to translate the initial query 504 between the source and destination database schemas and query languages based, at least in part, on the contextual data 568.

The language model 502 processes the metaprompt 526 to generate a preliminary translation result 532, which is provided to a query tester 558. The query tester 558 attempts to execute the preliminary translation result 532 on the destination database 508. If the execution attempt is carried out without error, the preliminary translation result 532 is returned as the final output, shown in FIG. 5 as “query translation 580.” Otherwise, observed execution errors 582 are provided as feedback to the metaprompt creator 556, which in turn generates an updated version of the metaprompt 526 that includes the execution errors 582, the preliminary translation result 132, and an updated translation instruction that instructs the language model 502 to re-try the translation based, at least in part, on the execution errors 582 and the preliminary translation result 532, such as per the operations generally described with respect to the error feedback loop 138 of FIG. 1.

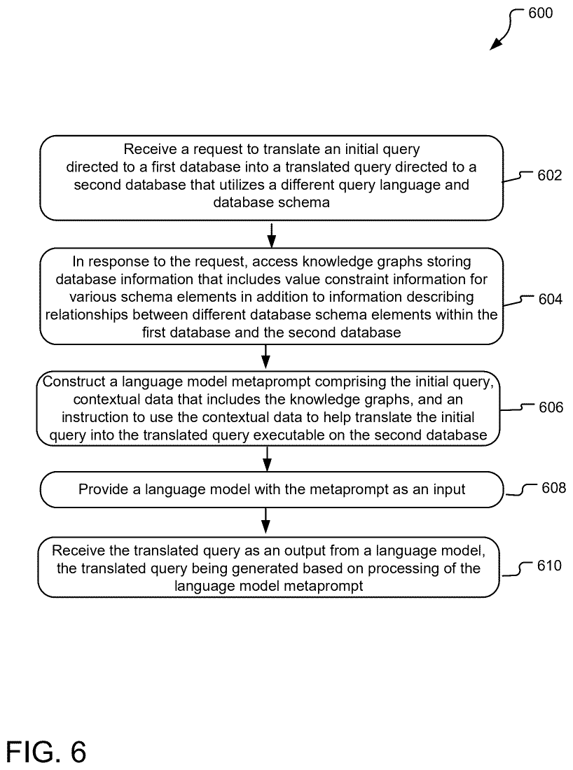

FIG. 6 illustrates example operations 600 for using artificial intelligence to translate database queries across query languages and between databases that organize data according to different database schemas. A receiving operation 602 receives a request to translate an initial query directed to a first database into a translated query directed to a second database that utilizes a different query language and schema. In response to the receiving operation 602, a graph lookup operation 604 accesses knowledge graphs storing database information that includes value constraint information for various schema elements in addition to information describing relationships between different database schema elements within the first database and the second database. For example, the value constraint information includes enumerated (e.g., sampled) values from the two databases and/or data type identifiers that describe the data types of values stored in different table/column pairs of the two databases.

Following the look-up operation 604, an input preparation operation 606 constructs a metaprompt comprising the initial query, contextual data that includes the knowledge graphs, and an instruction to use the contextual data to help translate the initial query into the translated query that is executable on the second database.

An input provisioning operation 608 provides the metaprompt as an input to a language model, and a receiving operation 610 receives the translated query as an output from the language model in response to the input provisioning operation 608.

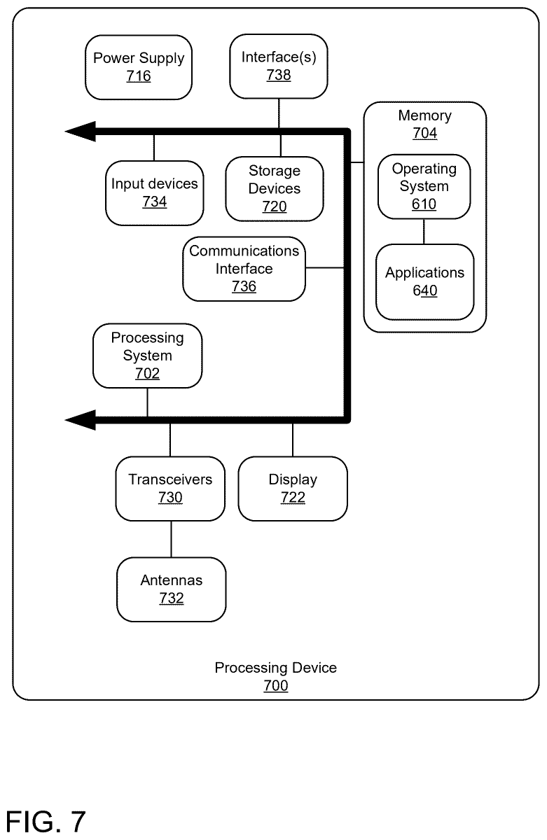

FIG. 7 illustrates an example computing device 700 for use in implementing the described technology. The computing device 700 may be a client computing device (such as a laptop computer, a desktop computer, or a tablet computer), a server/cloud computing device, an Internet-of-Things (IoT), any other type of computing device, or a combination of these options. The computing device 700 includes a processing system 702 and a memory 704. The memory 704 generally includes both volatile memory (e.g., RAM) and nonvolatile memory (e.g., flash memory), although one or the other type of memory may be omitted. An operating system 710 resides in the memory 704 and is executed by the processing system 702. In some implementations, the computing device 700 includes and/or is communicatively coupled to storage 720.

In the example computing device 770, as shown in FIG. 7, one or more software modules, segments, and/or processors, such as applications 750 (e.g., the query translator 112 of FIGS. 1, 312 of FIGS. 3, 412 of FIG. 4, or 512 of FIG. 5) are loaded into the memory 704 by the operating system 710 and executed by the processor(s) 772. The storage 720 may store knowledge graphs (e.g., the source DB knowledge graph 118 and destination DB knowledge graph 122), semantic data catalog information (e.g., as described with respect to FIG. 4), or sample query/translation pairs (e.g., a shot index 466 of FIG. 1).

The computing device 700 may include one or more communication transceivers 730, which may be connected to one or more antenna(s) 732 to provide network connectivity (e.g., mobile phone network, Wi-Fi®, Bluetooth®) to one or more other servers, client devices, IoT devices, and other computing and communications devices. The computing device 700 may further include a communications interface 736 (such as a network adapter or an I/O port, which are types of communication devices) that is used to establish connections over a wide-area network (WAN) or local-area network (LAN). It should be appreciated that the network connections shown are exemplary and that other communications devices and means for establishing a communications link between the computing device 700 and other devices may be used.

The computing device 700 may include one or more input devices 734 such that a user may enter commands and information (e.g., a keyboard, trackpad, or mouse). These and other input devices may be coupled to the server by one or more interfaces 738, such as a serial port interface, parallel port, or universal serial bus (USB). The computing device 700 may further include a display 722, such as a touchscreen display.

The computing device 700 may include a variety of tangible processor-readable storage media and intangible processor-readable communication signals. Tangible processor-readable storage can be embodied by any available media that can be accessed by the computing device 700 and can include both volatile and nonvolatile storage media and removable and non-removable storage media. Tangible processor-readable storage media excludes intangible, transitory communications signals (such as signals per se) and includes volatile and nonvolatile, removable, and non-removable storage media implemented in any method, process, or technology for storage of information such as processor-readable instructions, data structures, program modules, or other data. Tangible processor-readable storage media includes but is not limited to RAM, ROM, EEPROM, flash memory or other memory technology, CDROM, digital versatile disks (DVD) or other optical disk storage, magnetic cassettes, magnetic tape, magnetic disk storage, or other magnetic storage devices, or any other tangible medium which can be used to store the desired information and which can be accessed by the computing device 700. In contrast to tangible processor-readable storage media, intangible processor-readable communication signals may embody processor-readable instructions, data structures, program modules, or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

In some aspects, the techniques described herein relate to a method for translating a database query, the method including: receiving a request to translate an initial query directed to a first database into a translated query directed to a second database that utilizes a different query language; in response to the request, accessing contextual data including: a knowledge graphs corresponding to the first database and the second database, the knowledge graphs identifying database schema elements, relationships between schema elements, and value constraint information pertaining to values stored within the columns of the first and second database; and constructing a metaprompt including the initial query, the contextual data, and an instruction to use the contextual data to help translate the initial query into the translated query; and receiving the translated query as an output from a language model, the translated query being generated based on processing of the metaprompt.

In some aspects, the techniques described herein relate to a method, wherein the knowledge graphs store data type identifiers corresponding to columns within tables of the first database and the second database, wherein the value constraint information includes the data type identifiers.

In some aspects, the techniques described herein relate to a method, wherein the knowledge graphs includes sample sets of values stored within columns of the first database or the second database.

In some aspects, the techniques described herein relate to a method, further including: receiving an error message from the second database in response to attempting to execute an initial version of the translated query; generating an updated version of the metaprompt that includes the error message as part of the contextual data; and receiving the translated query in response to providing the updated version of the metaprompt to the language model; and executing the translated query to ensure error-free execution; and in response to successful execution of the translated query, returning the translated query.

In some aspects, the techniques described herein relate to a method, wherein the second database stores a same dataset as the first database according to a different database schema and wherein execution of the translated query on the second database retrieves information identical to that of the initial query executed on the first database.

In some aspects, the techniques described herein relate to a method, wherein the contextual data included within the metaprompt further includes a natural language annotation describing the initial query, and the method further includes instructing a second language model to generate the natural language annotation based on the initial query prior to generation of the metaprompt.

In some aspects, the techniques described herein relate to a method, further including: accessing a first semantic data catalog that includes descriptions of content stored within tables and columns of the first database; and extract, from the first semantic data catalog, one or more first schema element descriptions corresponding to schema elements referenced in the initial query, wherein the contextual data of the metaprompt further includes the one or more first schema element descriptions.

In some aspects, the techniques described herein relate to a method, further including: accessing an index of embeddings corresponding to schema element descriptions stored in a second semantic data catalog, the schema element descriptions in the second semantic data catalog being descriptive of tables and columns of the second database; comparing embeddings generated for the one or more first schema element descriptions of the schema elements referenced to the initial query to embeddings within the index of embeddings to identify a set of schema element descriptions in the second semantic data catalog with greatest semantic similarity to the one or more first schema element descriptions, wherein the contextual data further includes the set of schema element descriptions in the second semantic data catalog.

In some aspects, the techniques described herein relate to a method, further including: vectorizing the initial query to create a first embedding defined within latent space of a similarity model that stores embeddings corresponding to example queries executable on the first database, the example queries being indexed in association with corresponding example translations as part of a query/translation pair; comparing the first embedding to the embeddings stored by the similarity model to identify a select embedding of the embeddings that is most-similar to the first embedding; identifying the query/translation pair including the select embedding, wherein the contextual data of the metaprompt includes the query/translation pair.

In some aspects, the techniques described herein relate to a system including: memory; a processing system; a query translator stored in the memory and executable by the processing system to: receive a request to translate an initial query directed to a first database into a translated query directed to a second database that utilizes a different query language; access contextual data in response to receiving the request, the contextual data including: a first knowledge graph corresponding to a first database, the first knowledge graph storing relationships between tables and columns of the first database and information descriptive of a type of values stored within the columns of the first database; and a second knowledge graph corresponding to the second database, the second knowledge graph storing relationships between tables and columns of the second database and information descriptive of a type of values stored within the columns of the second database; and construct a metaprompt, the metaprompt including the initial query, the contextual data, and an instruction to use the contextual data to help translate the initial query into the translated query; receive the translated query from a language model in response to processing of the metaprompt by the language model; and execute the translated query to return requested data from the second database.

In some aspects, the techniques described herein relate to a system, wherein the first knowledge graph stores data type identifiers that identify data types stored within the columns, and wherein the first knowledge graph identifies a sample set of values stored for a plurality of the columns.

In some aspects, the techniques described herein relate to a system, wherein the query translator is further configured to receive an error message from the second database in response to an attempt to execute an initial version of the translated query; generate an updated version of the metaprompt that includes the error message as part of the contextual data; and receive the translated query in response to providing the updated version of the metaprompt to the language model; execute the translated query to ensure error-free execution; and in response to successful execution of the translated query, return the translated query.

In some aspects, the techniques described herein relate to a system, wherein the query translator is further configured to provide the initial query to a second language model along with a request to generate a natural language annotation describing the initial query, and wherein the contextual data of the metaprompt includes the natural language annotation of the initial query.

In some aspects, the techniques described herein relate to a system, wherein the contextual data included within the metaprompt further includes a natural language annotation describing the initial query, wherein the metaprompt instructs a second language model to generate the natural language annotation based on the initial query prior to generation of the metaprompt.

In some aspects, the techniques described herein relate to a system, wherein the query translator is further configured to: access a first semantic data catalog that includes descriptions of content stored within tables and columns of the first database; and extract, from the first semantic data catalog, one or more first schema element descriptions corresponding to schema elements referenced in the initial query, wherein the contextual data of the metaprompt further includes the one or more first schema element descriptions.

In some aspects, the techniques described herein relate to a system, wherein the query translator is further configured to: access an index of embeddings corresponding to schema element descriptions stored in a second semantic data catalog, the schema element descriptions in the second semantic data catalog being descriptive of tables and columns of the second database; compare embeddings generated for the one or more first schema element descriptions of the schema elements referenced to the initial query to embeddings within the index of embeddings to identify a set of schema element descriptions in the second semantic data catalog with greatest semantic similarity to the one or more first schema element descriptions, wherein the contextual data further includes the set of schema element descriptions in the second semantic data catalog.

In some aspects, the techniques described herein relate to a system, wherein the query translator is further configured to: vectorize the initial query to create a first embedding defined within latent space of a similarity model that stores embeddings corresponding to queries executable on the first database; compare the first embedding to the embeddings stored by the similarity model to identify a select embedding of the similarity model that is most-similar to the first embedding; and identify, from a shot database, a shot that is indexed in association with the select embedding of the similarity model, the shot including a natural language query in a first database language executable by the first database and a corresponding translation in a second database language executable by the second database, wherein the contextual data of the metaprompt includes the shot.

In some aspects, the techniques described herein relate to one or more tangible computer-readable storage media including processor-executable instructions for executing a computer process, the computer process including: in receiving a request to translate an initial query directed to a first database into a translated query directed to a second database that utilizes a different query language; in response to receiving the request, accessing contextual data including: a first knowledge graph corresponding to the first database, the first knowledge graph storing relationships between tables and columns of the first database and information descriptive of a type of values stored within the columns of the first database; and a second knowledge graph corresponding to the second database, the second knowledge graph storing relationships between tables and columns of the second database and information descriptive of a type of values stored within the columns of the second database; constructing a metaprompt including the initial query, the contextual data, and a translation instruction directing the language model to use the contextual data to help translate the initial query into the translated query; and receiving a preliminary translation result as an output from a language model, the translated query being generated based on processing of the metaprompt; receiving an error message in response to attempting to execute the preliminary translation result on the second database; generating an updated version of the metaprompt that includes the error message as and updated version of the translation instruction; receiving the translated query in response to providing the updated version of the metaprompt to the language model; and executing the translated query to ensure error-free execution; and in response to successful execution of the translated query, returning the translated query.

In some aspects, the techniques described herein relate to one or more tangible computer-readable storage media, wherein the first knowledge graph stores data type identifiers that identify data types stored within the columns, and wherein the first knowledge graph identifies a sample set of values stored for a plurality of the columns.

In some aspects, the techniques described herein relate to one or more tangible computer-readable storage media, wherein the computer process further includes: accessing a first semantic data catalog that includes descriptions of content stored within tables and columns of the first database; and extracting, from the first semantic data catalog, one or more first schema element descriptions corresponding to schema elements referenced in the initial query, wherein the contextual data of the metaprompt further includes the one or more first schema element descriptions.

The logical operations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language. The above specification, examples, and data, together with the attached appendices, provide a complete description of the structure and use of example implementations.

What is claimed is:

1. A method for translating a database query, the method comprising:
receiving a request to translate an initial query directed to a first database into a translated query directed to a second database that utilizes a different query language;
in response to the request, accessing contextual data comprising knowledge graphs corresponding to the first database and the second database, the knowledge graphs identifying database schema elements, relationships between the database schema elements, and value constraint information pertaining to values stored within the first database and the second database;
constructing a metaprompt comprising the initial query, the contextual data, and an instruction to use the contextual data to help translate the initial query into the translated query; and
receiving the translated query as an output from a language model, the translated query being generated based on processing of the metaprompt.

2. The method of claim 1, wherein the knowledge graphs store data type identifiers corresponding to columns within tables of the first database and the second database, wherein the value constraint information includes the data type identifiers.

3. The method of claim 2, wherein the knowledge graphs include sample sets of values stored within columns of the first database or the second database.

4. The method of claim 1, further comprising:
receiving an execution error from the second database in response to attempting to execute an initial version of the translated query;
generating an updated version of the metaprompt that includes the execution error as part of the contextual data; and
receiving the translated query in response to providing the updated version of the metaprompt to the language model; and
executing the translated query to ensure error-free execution; and
in response to successful execution of the translated query, returning the translated query.

5. The method of claim 1, wherein the second database stores a same dataset as the first database according to a different database schema and wherein execution of the translated query on the second database retrieves information identical to that of the initial query executed on the first database.

6. The method of claim 1, wherein the contextual data included within the metaprompt further includes a natural language annotation describing the initial query, and the method further includes instructing a second language model to generate the natural language annotation based on the initial query prior to generation of the metaprompt.

7. The method of claim 1, further comprising:
accessing a first semantic data catalog that includes descriptions of content stored within tables and columns of the first database; and
extract, from the first semantic data catalog, one or more first schema element descriptions corresponding to schema elements referenced in the initial query, wherein the contextual data of the metaprompt further includes the one or more first schema element descriptions.

8. The method of claim 7, further comprising:
accessing an index of embeddings corresponding to schema element descriptions stored in a second semantic data catalog, the schema element descriptions in the second semantic data catalog being descriptive of tables and columns of the second database;
comparing embeddings generated for the one or more first schema element descriptions of the schema elements referenced to the initial query to embeddings within the index of embeddings to identify a set of schema element descriptions in the second semantic data catalog with greatest semantic similarity to the one or more first schema element descriptions, wherein the contextual data further includes the set of schema element descriptions in the second semantic data catalog.

9. The method of claim 1, further comprising:
vectorizing the initial query to create a first embedding defined within latent space of a similarity model that stores embeddings corresponding to example queries executable on the first database, the example queries being indexed in association with corresponding example translations as part of a query/translation pair;
comparing the first embedding to the embeddings stored by the similarity model to identify a select embedding of the embeddings that is most-similar to the first embedding;
identifying the query/translation pair including the select embedding, wherein the contextual data of the metaprompt includes the query/translation pair.

10. A system comprising:
memory;
a processing system;
a query translator stored in the memory and executable by the processing system to:
receive a request to translate an initial query directed to a first database into a translated query directed to a second database that utilizes a different query language;
access contextual data in response to receiving the request, the contextual data comprising:
a first knowledge graph corresponding to a first database, the first knowledge graph storing relationships between tables and columns of the first database and first information descriptive of a first type of values stored within the columns of the first database; and
a second knowledge graph corresponding to the second database, the second knowledge graph storing relationships between tables and columns of the second database and second information descriptive of a second type of values stored within the columns of the second database;
construct a metaprompt, the metaprompt comprising the initial query, the contextual data, and an instruction to use the contextual data to help translate the initial query into the translated query;
receive the translated query from a language model in response to processing of the metaprompt by the language model; and
execute the translated query to return requested data from the second database.

11. The system of claim 10, wherein the first knowledge graph stores data type identifiers that identify data types stored within the columns, and wherein the first knowledge graph identifies a sample set of values stored for a plurality of the columns.

12. The system of claim 10, wherein the query translator is further configured to
receive an execution error from the second database in response to an attempt to execute an initial version of the translated query;
generate an updated version of the metaprompt that includes the error message as part of the contextual data; and
receive the translated query in response to providing the updated version of the metaprompt to the language model;
execute the translated query to ensure error-free execution; and
in response to successful execution of the translated query, return the translated query.

13. The system of claim 10, wherein the query translator is further configured to provide the initial query to a second language model along with a request to generate a natural language annotation describing the initial query, and wherein the contextual data of the metaprompt includes the natural language annotation of the initial query.

14. The system of claim 10, wherein the contextual data included within the metaprompt further includes a natural language annotation describing the initial query, wherein the metaprompt instructs a second language model to generate the natural language annotation based on the initial query prior to generation of the metaprompt.

15. The system of claim 10, wherein the query translator is further configured to:
access a first semantic data catalog that includes descriptions of content stored within tables and columns of the first database; and
extract, from the first semantic data catalog, one or more first schema element descriptions corresponding to schema elements referenced in the initial query, wherein the contextual data of the metaprompt further includes the one or more first schema element descriptions.

16. The system of claim 15, wherein the query translator is further configured to:
access an index of embeddings corresponding to schema element descriptions stored in a second semantic data catalog, the schema element descriptions in the second semantic data catalog being descriptive of tables and columns of the second database;
compare embeddings generated for the one or more first schema element descriptions of the schema elements referenced to the initial query to embeddings within the index of embeddings to identify a set of schema element descriptions in the second semantic data catalog with greatest semantic similarity to the one or more first schema element descriptions, wherein the contextual data further includes the set of schema element descriptions in the second semantic data catalog.

17. The system of claim 10, wherein the query translator is further configured to:
vectorize the initial query to create a first embedding defined within latent space of a similarity model that stores embeddings corresponding to queries executable on the first database;
compare the first embedding to the embeddings stored by the similarity model to identify a select embedding of the similarity model that is most-similar to the first embedding; and
identify, from a shot database, a shot that is indexed in association with the select embedding of the similarity model, the shot including a natural language query in a first database language executable by the first database and a corresponding translation in a second database language executable by the second database, wherein the contextual data of the metaprompt includes the shot.

18. One or more tangible computer-readable storage media including processor-executable
instructions for executing a computer process, the computer process comprising:
in receiving a request to translate an initial query directed to a first database into a translated query directed to a second database that utilizes a different query language;
in response to receiving the request, accessing contextual data comprising:
a first knowledge graph corresponding to the first database, the first knowledge graph storing relationships between tables and columns of the first database and information descriptive of a type of values stored within the columns of the first database; and
a second knowledge graph corresponding to the second database, the second knowledge graph storing relationships between tables and columns of the second database and information descriptive of a type of values stored within the columns of the second database;
constructing a metaprompt comprising the initial query, the contextual data, and a translation instruction directing the language model to use the contextual data to help translate the initial query into the translated query;
receiving a preliminary translation result as an output from a language model, the translated query being generated based on processing of the metaprompt;
receiving an execution error in response to attempting to execute the preliminary translation result on the second database;
generating an updated version of the metaprompt that includes the execution error as and updated version of the translation instruction;
receiving the translated query in response to providing the updated version of the metaprompt to the language model;
executing the translated query to ensure error-free execution; and
in response to successful execution of the translated query, returning the translated query.

19. The one or more tangible computer-readable storage media of claim 18, wherein the first knowledge graph stores data type identifiers that identify data types stored within the columns, and wherein the first knowledge graph identifies a sample set of values stored for a plurality of the columns.

20. The one or more tangible computer-readable storage media of claim 18, wherein the computer process further comprises:
accessing a first semantic data catalog that includes descriptions of content stored within tables and columns of the first database; and
extracting, from the first semantic data catalog, one or more first schema element descriptions corresponding to schema elements referenced in the initial query, wherein the contextual data of the metaprompt further includes the one or more first schema element descriptions.
